(19) United States
(12) Patent Application Publication
(10) Pub. No.: US 2008/0248841 A1
(43) Pub. Date: Oct. 9, 2008

(54) Ventilation For a Portable Electronic Device

(76) Inventors: Ji Woei Amos Foo, Singapore (SG); Yen Jason Chin, Singapore (SG); Tze Wei Henry Wong, Singapore (SG); Ah Hock Law, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/088,183

(22) PCT Filed: Sep. 30, 2005
(86) PCT No.: PCT/SG2005/000332

§ 371 Date: Mar. 26, 2008

(51) Int. Cl. H04M 1/00

(52) U.S. Cl. 455/575.1

(57) ABSTRACT

A portable electronic device comprising a casing (5); a speaker (20) mounted adjacent an orifice (10) of the casing (5); an air permeable membrane (25) sealingly mounted to the cading (5) intermediate the orifice (10) and the speaker (20), so as to form a chamber (35) between the speaker (20) and the membrane (25); wherein the membrane (25) permits the ingress and egress of air (30), into the casing (5) through the orifice (10).

### FIELD OF THE INVENTION

The invention relates to portable electronic devices, such as PDA's, and in particular those used for industrial applications. Specifically, the invention relates to means for adjusting the casing of such a device for enhanced performance, and specifically for ventilation of the casing.

### BACKGROUND

For electronic devices, the internal components generate a considerable amount of heat, which must be dissipated. Whilst desk-top applications can incorporate fans to provide a flow of air through the internal componentry, such a flow of air is not available to smaller electronic devices particularly those which are considered portable, as the incorporation of a fan is impractical.

However, such smaller electronic devices may not require a considerable flow of air in order to dissipate heat because of the comparatively small amount of heat generated or intermittent use as compared to the more continual use of electronic devices normally used in commercial environments.

Thus, portable electronic devices can usually suffice with having vents within the casing to allow heated air to dissipate out of the device.

A special class of such portable electronic devices are those used in industrial applications, as distinct from similar commercial devices which are not sufficiently protected from the adverse environments experienced for industrial applications. For instance, dust, dirt, moisture etc. can seriously affect the practical and commercial life of a device. Commercial devices are not designed to resist such adverse environmental considerations and therefore may not have a sufficiently long effective life to warrant the cost of having such devices in an industrial environment. Therefore, portable electronic devices geared to industrial applications will at least seek to have protection against the ingress of dirt, dust and moisture, which inter alia are predisposing causes to the failure of such devices.

Thus, the problem of dissipating heated air from a device adapted for industrial use presents a particularly difficult issue. Because said devices are protected from the ingress of undesirable materials, said devices are frequently air and water tight. Consequently, not only does such a portable electronic device have no fan to help dissipate the heated air, in fact, the heated air cannot escape from the device itself.

Consequently, it is known for such devices to explode due to pressure and heat build-up causing both a shortened life of the device and possibly a safety hazard.

### SUMMARY OF THE INVENTION

It is therefore an object of the present invention to avoid the build-up of such heated air for a device adapted for industrial use.

In a first aspect, the invention provides a portable electronic device comprising a casing;

a speaker mounted adjacent an orifice of the casing;

an air permeable membrane mounted to the casing intermediate the orifice and the speaker, so as to form a chamber between the speaker and the membrane, wherein;

the membrane prevents ingress of water, but permits the ingress and egress of air, into the casing through the orifice.

Thus, by providing a seal in the casing of the device that permits the free flow of air but prevents the ingress of water, the portable electronic device is protected from damaging ingress of materials, but allows for the venting of hot air from the device thus avoiding said device from exploding.

The invention has the further advantage in that by providing ventilation of the hot air at the point of the speaker, extra ventilation points are not required. On the basis that the chance of moisture penetrating the casing is increased in proportion to the number of openings in the casing by combining the purpose of the orifice for a speaker and a ventilation port, the double use of the orifice halves the number of opportunities through which water can penetrate the casing.

Further, the size of a speaker in such a device may be proportionally large within such a device. Thus, by providing a combined ventilation port and speaker, the area through which air may vent may be larger and thus provide much higher capacity for the venting of hot air than would normally be provided through smaller, conventional venting holes.

In a preferred embodiment, the advantage of combining the speaker orifice with the vent port provides the opportunity to structure the arrangement so as to provide a protected sound chamber for the speaker. Thus, in this preferred embodiment by forming a chamber between the membrane and the speaker, so as to be of sufficient size may enhance the audio quality of the speaker and so increase the performance of the electronic device whilst also providing a means through which hot air may be ventilated.

### BRIEF DESCRIPTION OF DRAWINGS

FIG. 1 shows an isometric view of the portable electronic device according to one embodiment of the present invention;

FIG. 2 shows a sectional view of the speaker according to the embodiment of FIG. 1.

It will be convenient to further describe the present invention with respect to the accompanying drawings, which illustrate a possible arrangement of the invention. Other arrangements of the invention are possible and consequently the particularity of the accompanying drawings is not to be understood as superceding the generality of the preceding description of the invention.

### DESCRIPTION OF PREFERRED EMBODIMENT

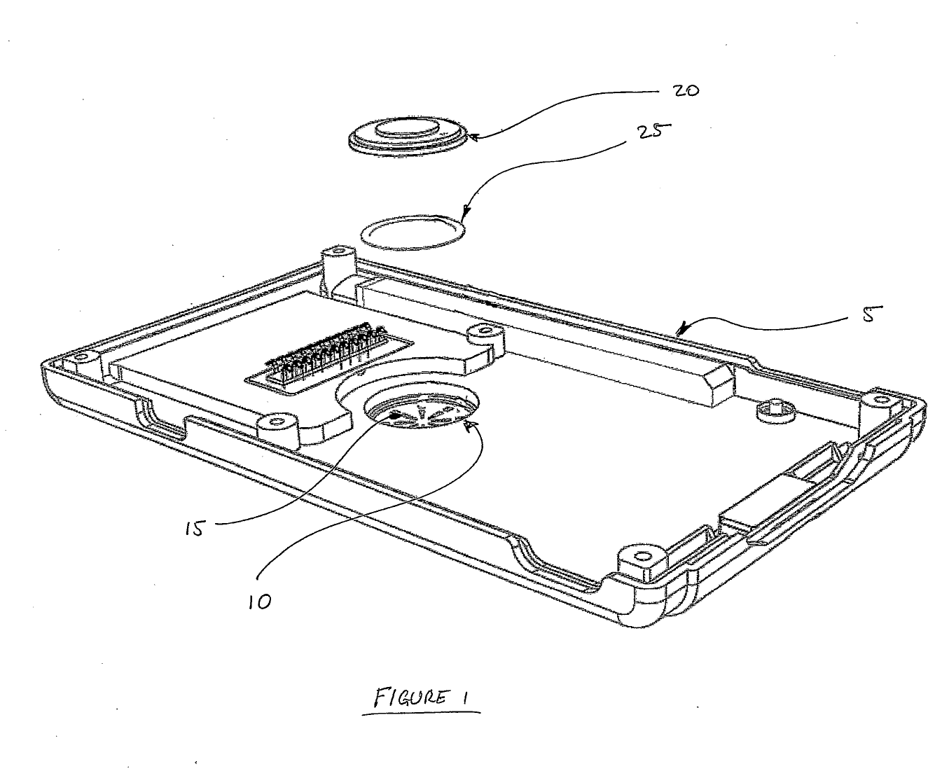

FIG. 1 shows one embodiment of the present invention, in particular, a casing of a portable electronic device has been removed so as to examine the internal componentry. In particular, this view shows a circular orifice 10 has been moulded into the casing 5 so as to fit a speaker 20. The orifice 10 includes a covering with holes 15 placed in it such that anything passing through the orifice 10 must also pass through the holes 15. Further shown in this view is a membrane 25 which, in the exploded view of FIG. 1, is placed intermediate the orifice 10 and the speaker 20.

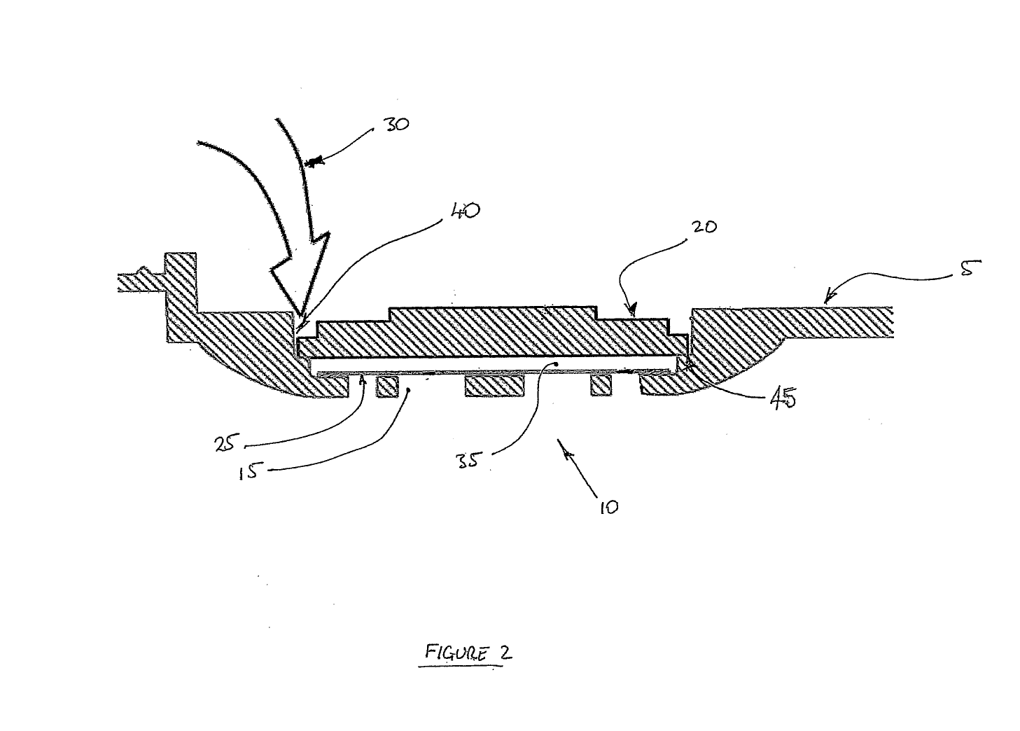

FIG. 2 shows a detailed cross-sectional view of the assembly associated with the orifice 10.

It will be seen that adjacent the orifice 10 is a recess 40 having a step 45 into which the speaker 20 will fit ready for mounting within the casing 5, either glued or otherwise fixed to the casing 5. Abutting the orifice 10 is a membrane 25 of a suitable material which is both waterproof and permeable to air. A suitable material may be TEMISH™ film from Nitto Denko. This material is merely one such suitable material, and in no way limits the invention to this material. It will be clear to the skilled addressee that many such materials could be used also, and still fall within the scope of the invention, without undue experimentation. The membrane 25 is glued to the casing 5, so as to completely cover and seal the orifice 10. An alternative arrangement may have the membrane 25 merely covering the holes 15, which would reduce the material required but substantially increase the manufacturing costs. Whilst this embodiment shows the membrane 25 abutting the orifice 10, an alternative arrangement may have the membrane 25 sealing the recess 40 into which the speaker has been mounted. Whilst this may permit the build-up of detritus within the chamber 35, the membrane would permit the sealing of the electronic device whilst also permitting the flow of air.

In a further preferred embodiment, having the membrane 25 abutting the orifice 10, forms a chamber 35 in an interstitial space between the membrane 25 and the speaker 20. The placement of this chamber 35 permits it to act as a sound chamber for the speaker and so considerably increase the performance of the speaker whilst still satisfying the objectives of the invention.

A major consideration for the invention is the ability of heated air 30 to escape from the electronic device so as to prevent the device exploding. By securing the speaker 20 into the recess 40 in a manner that still permits the flow of air, then the heated air can enter the chamber 35 and pass through the membrane 25 and so escape to the atmosphere. Thus, the air permeable/waterproof membrane 25 serves the dual function of protecting the device from the ingress of water whilst also permitting the egress of hot air into the atmosphere through the orifice 10.

That which is claimed:

1. A portable electronic device comprising:
a casing;
a speaker mounted adjacent an orifice of the casing;
an air permeable membrane sealingly mounted to the casing intermediate the orifice and the speaker, so as to form a chamber between the speaker and the membrane; and
wherein the membrane permits the ingress and egress of air, into the casing through the orifice.

2. The device according to claim 1, wherein said membrane is waterproof and mounted such that water ingress through the orifice is prevented.

3. The device according to claim 1, wherein the passage of air and water is only permitted into the casing through the orifice, said passage of water prevented by the mounted membrane.

4. The device according to claim 1, wherein the orifice comprises a plurality of holes in a portion of the casing.

5. The device according to claim 1, wherein the chamber acts as a sound chamber for the speaker.
